(19) United States
(12) Patent Application Publication
(10) Pub. No.: US 2003/0029079 A1
(43) Pub. Date: Feb. 13, 2003

(54) Tree and shrub pest control device

(76) Inventor: R. Amil Kleinert, Charlestown, IN (US)

Correspondence Address: JOHN F. SALAZAR, MIDDLETON & REUTLINGER, 2500 BROWN & WILLIAMSON TOWER, LOUISVILLE, KY, 40202, US

(21) Appl. No.: 10/216,972

(22) Filed: Aug. 12, 2002

Related U.S. Application Data
(60) Provisional application No. 60/311,808, filed on Aug. 13, 2001.

(51) Int. Cl. A01G 13/02

(52) U.S. Cl. 47/32.4

(57) ABSTRACT

A pest deterrent device having first and second mating sections forming a substantially cylindrically shaped body including a smooth outer surface. Each mating section has at least one latch and a plurality of alignment fingers disposed along a first vertical terminating edge of each mating section. Each mating section also has at least one loop aligned with the at least one latch along a second terminating edge side thereof. The first and second sections include a lip extending radially outward from said cylindrical body and a plurality of feet extending downwardly from a lower edge.

### BACKGROUND

The present invention relates to a pest deterrent device to be placed about the base of a tree or similar growing plant. The device reduces the risk that crawling pests, such as tent caterpillars, can reach the trunk of the tree and cause damage to the tree.

Crawling insects and similar pests which travel along the ground, such as tent caterpillars, can defoliate a tree or shrub in a very short period of time. If the pests are extremely persistent, the tree can fail to survive the pest attack.

The prior art includes various attempts to control the travel of the crawling pests. For example, U.S. Pat. No. 6,223,463 describes a band or collar that encircles the trunk of a tree or a post and which has an exterior surface with a coefficient of friction of from about 0.05μ-0.45μ. U.S. Pat. No. 6,230,435 describes a collar that encircles the trunk of a tree and that includes a recess for holding a material, such as mineral oil or vegetable oil, which creates a barrier to prevent the pests from continuing their climb into the branches of the tree. Unfortunately, while the tree may be protected from crawling pests, damage may be caused by the means used to attach the collar to the tree. For example, the '463 collar is attached to the tree with an adhesive material, and the '435 collar is attached to the tree with nails or screws. Further, by having the collars held tightly against the tree's trunk, as needed to prevent the pests from crawling between the trunk and the collar, the tree's growth is restricted in the area where the collar is positioned.

The tree's trunk can also suffer damage by being hit, particularly near the base, with lawn mower blades and nylon string used in “weed-whackers.” Even mulch placed right at the base of the tree can cause undue stress and potential death to the tree. For example, devices to protect the tree's trunk from damage near the base are described in U.S. Pat. No. 5,809,689, U.S. Pat. No. 5,060,416, U.S. Pat. No. 4,845,889 and U.S. Pat. No. 4,700,507. However, these devices are not designed to prevent crawling pests from gaining access to the tree trunk, and possibly to the upper portion of the tree.

### SUMMARY

The present invention relates to a pest deterrent device to be placed about the base of a tree or similar growing plant. The device includes a smooth surfaced cylindrical body having a lip which extends outwardly from an upper edge of the body and means to secure the device into the ground extending downwardly from a lower edge of the body. The lip reduces the risk that crawling pests, such as tent caterpillars, can reach the trunk of the tree and cause damage to the tree. A plurality of apertures in the body allow for air to circulate about the tree when the device is positioned about the base of the tree. Optionally, the device may include indicia, such as a recommended mulch level line.

### SUMMARY OF THE FIGURES

FIG. 1 is a representative illustration of a pest deterrent device made in accordance with the present invention positioned around the base of a tree;

FIG. 2 is a perspective view of a section of the pest deterrent device of FIG. 1 showing the interior surface;

FIG. 3 is a perspective view of a section of the pest deterrent device of FIG. 1 showing the exterior surface;

FIG. 4 is a perspective view of a section of an alternative embodiment of the pest deterrent device showing the exterior surface;

FIG. 5 is a perspective view of a section of an alternative embodiment of the pest deterrent device showing the interior surface; and

FIG. 6 is an exploded view of the pest deterrent device of FIG. 1 including an optional frost cap.

### DETAILED DESCRIPTION

The present invention relates to a pest deterrent device to be placed about the base of a tree or similar growing plant. The device is designed to reduce the risk that crawling pests, such as tent caterpillars, can reach the trunk of the tree and cause damage to the tree. The device is further designed to minimize any health risks to the tree while the device is being used.

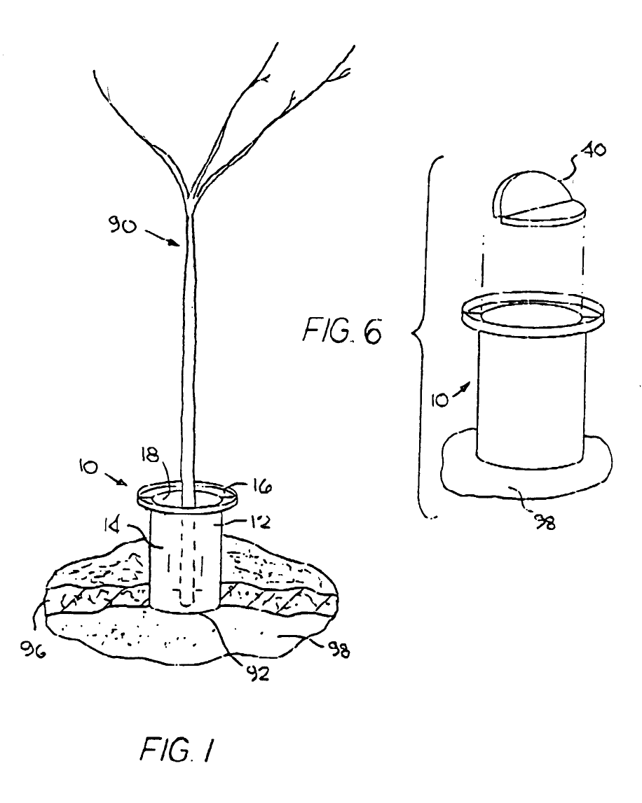

As shown in FIG. 1, a pest deterrent device 10 made in accordance with the present invention is intended to encircle the base 92 of a tree 90. The device 10 is designed to rest tightly against the ground 98, thereby preventing crawling pests, cutworms, rabbits, squirrels and other rodents, from gaining access to the tree trunk by crawling under the base of the pest deterrent device. Because the device 10 encircles the base 92 of the tree 90, the device 10 can also prevent lawn mower and/or grass trimmer damage to the tree trunk 94. Optionally, mulch 96 or similar ground cover may be placed around the tree 90 against an exterior surface 12 of the device 10. The device 10 prevents the mulch 96 from resting directly against the tree 90 and, thus, potentially harming the tree 90.

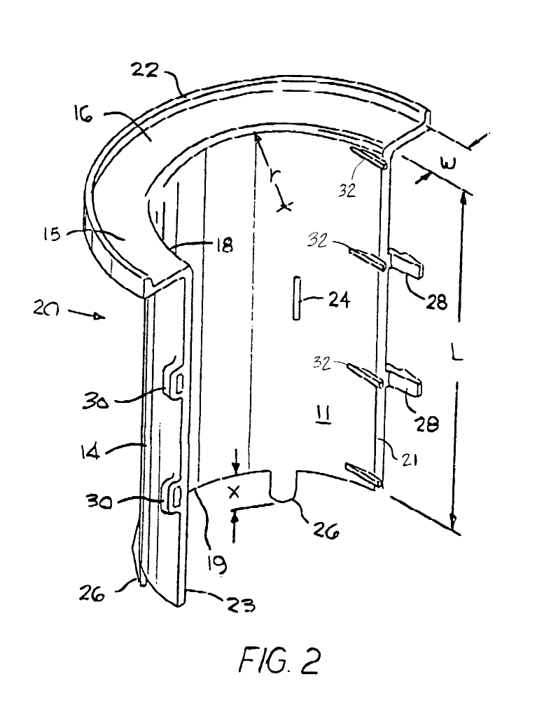

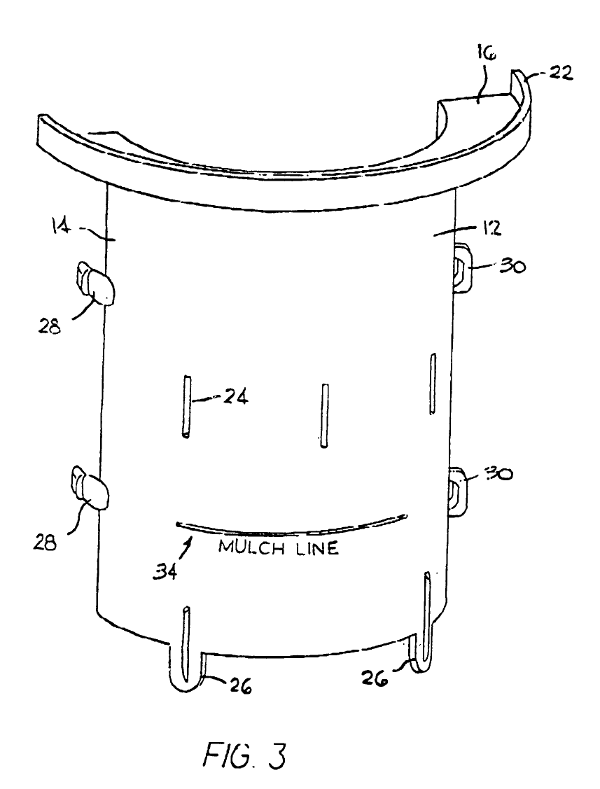

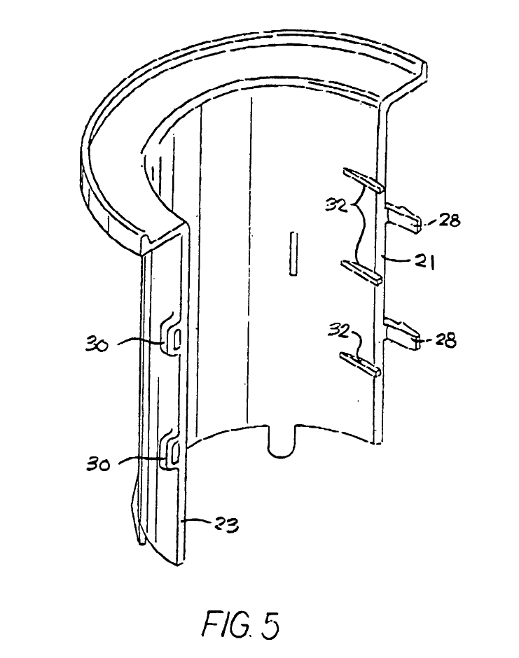

As shown in FIGS. 1-6, the pest deterrent device 10 includes a smooth surfaced cylindrical body 14. In the embodiment shown, the body 14 is divided into two essentially identical semi-circular mating sections, of which one section 20 is shown in FIGS. 2 and 3. The section 20 has an interior surface 11 and an exterior surface 12, a radius “r” and a length “L.” The radius “r” may be varied to accommodate trees with different diameter trunks. In an example embodiment, the radius “r” is about 3″ so that when two sections are combined to form a cylindrical device 10, the diameter of the device is about 6″, and the length “L” is about 10″ from an upper edge 18 to a lower edge 19 of the body 14. Preferably, the cylindrical body 14 has a smooth exterior surface 12 so that crawling pests cannot retain traction and climb along the exterior surface 12.

A lip or flange 16, having a width “W”, extends outwardly from the exterior surface 12 of the body 14. In the embodiment shown, the lip or flange 16 extends radially outward from the upper edge 18, although the lip 16 may be positioned essentially anywhere along the exterior surface 12. The lip 16 has an upper side 15 facing toward the branches of the tree 90 and an underside 17 facing toward the ground 98 when the device is in use. The outward extension of the lip 16 provides a deterrent for crawling pests. Even if a crawling pest is able to scale the body 14, when the pest begins to crawl along the underside 17 of the lip 16, gravitational forces will increase the probability that the pest will fall from the device 10 before reaching the upper side 15. Optionally, the lip 16 may further include a rim 22 which extends upwardly from an outer edge 17 of the lip 16. In an example embodiment, the lip 16 has a width “W” of about 1¼″ with a ½″ rim 22.

The body 14 includes a plurality of apertures 24. The apertures 24 may vary in design and dimension and are included to allow air to circulate about the tree 90 when the device 10 is positioned about the base 92 of the tree 90. However, the apertures 24 should be sized such that crawling pests cannot easily pass through the apertures 24 to reach the interior surface 11 of the section 20. In one preferred embodiment, the apertures 24 are 1″×1/16″ slits positioned about 4″ from the upper edge 18 of the body 14 and separated from each other by about 2½″.

The section 20 also includes one or more feet 26 extending vertically downward from the lower edge 19 by a length “X”. The feet 26 allow the device 10 to be secured into the ground 98. The shape of the feet 26 may vary as desired by the user. For example, the feet 26 may be slightly rounded, as shown. Alternatively, the feet 26 may be pointed to more easily force the feet 26 into the ground 98, or barbed to minimize the risk of the device being pulled from the ground 98. The length “X” of the feet 26 can vary as desired by the user. As is known in the art, a longer foot 26 will provide a better ground anchor, but may be more difficult to force into the ground 98 such that the lower edge 19 of the device 10 rests against the ground 98. Thus, the length of the feet 26 may be modified for different soil types. For example, soft soil might use a longer rounded foot, whereas clay soil might be better served with a shorter pointed foot.

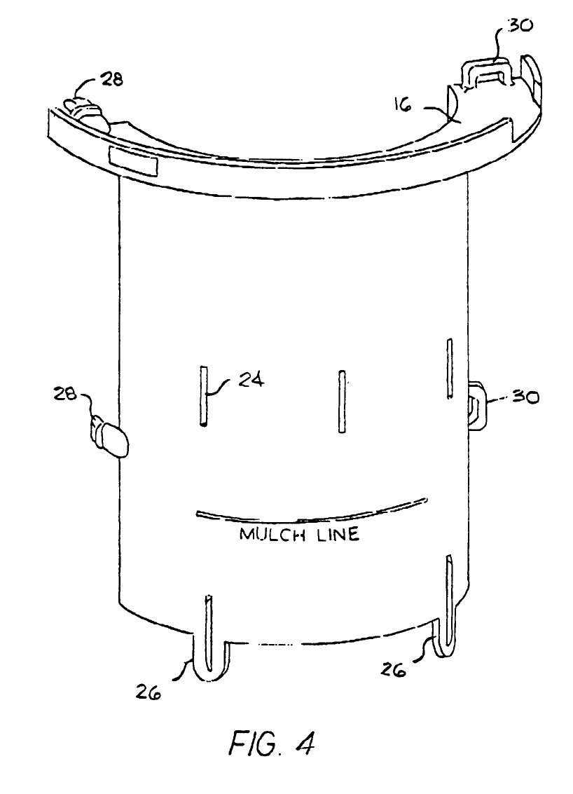

The section 20 further includes mating first 21 and second 23 opposed terminating vertical edges or sides, and means for attaching one section 20 to an essentially identical section 20. For example, in the embodiment shown in FIGS. 1-6, the first and second opposed vertical terminating edges 21, 23 are essentially straight and flat-edged with hooked latches 28 extending outward from the first side 21 and receivers or loops 30 affixed to the second side 23. The sides 21, 23 may also be angled, beveled, or curved, or may include other interacting designs that will result in a smooth, continuous seam along the exterior face 12 of the device 10 when sections 20 are united. The latches 28 are designed to matingly engage the receivers 30 forming fasteners. The number of latches 28 and receivers 30 may vary as desired by the user. Alternatively, any appropriate attaching means can be used in place of the latches 28 and receivers 30. Further, as shown in FIG. 4, the latches 28 and receivers 30 may also be affixed to the lip 16, if desired. In the embodiment shown in FIG. 4, the latch 28 and receivers 30 are on the upper side 15 of the lip 16, but latch 28 and loop 30 may be mounted on the lower side 17.

In an alternative embodiment, two sections may be essentially identical except for the attaching means. In this case, one section may include latching-type units while the second section includes receiving units. For example, the two sections may include interacting hinges along one pair of matching edges, and latch/loop combinations along a second pair of matching edges.

Optionally, the section 20 may include additional features, such as keepers 32, and text or other indicia 34 for use. The keepers 32 extend outward slightly from the first side 21 and function to keep the sides aligned during use. Alternatively, the keepers 32 could extend outward from the second side 23 or could alternate between the first and second sides 21, 23. The number and spacing of the keepers 32 may vary as desired by the user. Text or other indicia 34 may also be included on the section 20. For example, the section 20 may include a line or similar marking on the exterior surface 12 showing a recommended mulch level for plantings. As shown in FIG. 6, peripheral items may also be used with the pest deterrent device 10, such as a removable frost cover 40 which can fit over the top of the device 10 when used with small plants.

From a reading of the above, one with ordinary skill in the art should be able to devise variations to the inventive features. For example, the pest deterrent device 10 may be used with plants other than trees. The device 10 may also be divided into smaller sections 20, thereby requiring more than two sections 20 to be combined to form a complete device 10. Further, the various section dimensions may be optimized for different size trees or other growing plants. These and other variations are believed to fall within the spirit and scope of the attached claims.

I claim:

1. A mating section for a pest deterrent device, comprising:
a mating section of substantially half-cylindrical shape, said mating section having a first and a second opposed terminating vertical edge defining a sidewall there between;
a lip extending radially outward from an upper edge of said mating section between said first and second opposed terminating vertical edges;
at least one fastener aligned along said first and second opposed terminating edges.

2. The mating section for a pest deterrent device of claim 1 further comprising a plurality of air flow-through apertures in said sidewall.

3. The mating section for a pest deterrent device of claim 1, said lip having a vertical rim extending from a peripheral edge thereof.

4. The mating section for a pest deterrent device of claim 1 further comprising a plurality of feet extending vertically downward from a lower edge of said first section.

5. The mating section for a pest deterrent device of claim 1 further comprising a plurality of alignment fingers spaced along said first terminating edge.

6. The mating section for a pest deterrent device of claim 5, said alignment fingers extending from an inner surface of said mating section.

7. The mating section for a pest deterrent device of claim 1, further comprising an identical mating section.

8. The mating section for a pest deterrent device of claim 1, said mating section having at least one latch extending from said first opposed terminating edge and at least one aligned receiver along said second opposed terminating edge.

9. A pest deterrent device, comprising:
a first section and a second section, said first and second sections forming a substantially cylindrical body;
said substantially cylindrical body having a lip radially extending about an upper edge thereof;
said first mating section and said second mating section each having a plurality of alignment fingers and a plurality of latches along a first opposed terminating vertical edge;
said first mating section and said second mating section each having a plurality of receivers symmetrically aligned with said plurality of latches along a second opposed terminating vertical edge; and,
an exterior surface of said cylindrical body being smooth.

10. The pest deterrent device of claim 9 further comprising at least one air flow-through aperture disposed along said substantially cylindrical body.

11. The pest deterrent device of claim 9, said cylindrical body having a plurality of feet extending vertically downward from a lower edge of said substantially cylindrical body.

12. The pest deterrent device of claim 9, said plurality of alignment fingers extending from an inner surface of said first side of said first and second mating sections.

13. The pest deterrent device of claim 9, said plurality of latches extending from an outer surface of said first opposed terminating vertical edge of said first and second mating sections.

14. The pest deterrent device of claim 9, said plurality of receivers extending from an outer surface of said second opposed terminating vertical edge of said first and second mating sections.

15. The pest deterrent device of claim 9, said body having a mulch line extending about an exterior surface of said body.

16. A mating section for a pest deterrent device, comprising:
a mating section of substantially half-cylinder shape, said mating section having a first and a second opposed terminating vertical edge;
an exterior surface of said mating section being smooth;
a flange extending radially outward from an upper edge of said mating section and an upwardly extending rim extending from an outer edge of said lip;
at least one latch extending from said first opposed terminating vertical edge;
at least one receiver symmetrically disposed opposite at least one latch and extending from said second opposed terminating vertical edge;
at least one latch extending from said lip and at least one symmetrically aligned receiver extending from said lip; and,
a plurality of air-flow through apertures along said mating section.

17. The mating section for a pest deterrent device of claim 16 further comprising a plurality of feet extending from a lower edge of said mating section.

18. The mating section for a pest deterrent device of claim 16 further comprising a mulch line along an outer surface thereof.

19. A pest deterrent device, comprising:
a first mating section and a second mating section forming a substantially cylindrical body with a centrally disposed opening;
said cylindrical body having a lip extending radially outward about an upper edge of said cylindrical body;
said first mating section and said second mating section each having at least one alignment finger and at least one latch along a first opposed terminating vertical edge;
at least one receiver symmetrically aligned with said at least one latch along a second opposed terminating vertical edge;
at least one latch along a first side of said lip and at least one receiver spaced apart about 180 degrees therefrom;
a plurality of air flow-through apertures disposed along said cylindrical body;
a mulch line extending along an outer surface of said substantially cylindrical body; and,
a plurality of feet extending along a lower edge of said body.

20. The pest deterrent device of claim 19, said substantially cylindrical body further comprising a frost cap sized to fit within said centrally disposed opening.

21. A mating section for a pest deterrent device, comprising:
a mating section of substantially half-cylindrical shape, said mating section having a first and a second opposed terminating vertical edge;
a lip extending radially outward from an upper edge of said mating section;
a plurality of latches extending along said first terminating edge;
a plurality of receivers disposed along said second terminating edge of said first section aligned with said latches;
said pest deterrent device comprising two mating sections.

22. The mating section for a pest deterrent device of claim 21, said two mating sections being identical.
